(19) United States
(12) Patent Application Publication
(10) Pub. No.: US 2013/0135190 A1
(43) Pub. Date: May 30, 2013

(54) ELECTRONIC DEVICE, STORAGE MEDIUM, AND METHOD FOR EXECUTING MULTIPLE FUNCTIONS OF PHYSICAL BUTTON OF THE ELECTRONIC DEVICE

(71) Applicant: WEN-SHIAN HUANG, Shindian (TW)

(72) Inventor: WEN-SHIAN HUANG, Shindian (TW)

(73) Assignee: FIH (HONG KONG) LIMITED, Kowloon (HK)

(21) Appl. No.: 13/461,741

(22) Filed: May 1, 2012

(30) Foreign Application Priority Data
Nov. 29, 2011 (TW) 100143826

(51) Int. Cl. G09G 5/00

(52) U.S. Cl. 345/156

(57) ABSTRACT

In a method for executing multiple functions of a physical button of an electronic device, multiple functions of the physical button are predefined, and a relationship between each of the multiple functions and each placement state of the electronic device is predefined. One of the placement states of the electronic device is detected when the physical button is pressed. A function of the physical button corresponding to the detected placement state of the electronic device is determined according to the predefined relationship. The electronic device is controlled to execute the determined function of the physical button.

### BACKGROUND

1. Technical Field

Embodiments of the present disclosure relate to systems and methods for operating electronic devices, and more particularly, to an electronic device, a storage medium, and a method for executing multiple functions of a physical button of the electronic device.

2. Description of Related Art

An electronic device with a touch screen may only have a few physical buttons, such as a power button. However, some applications of the electronic device, such as games or a media player, may need more physical buttons to support the applications. What is needed, therefore, is a method for executing multiple functions of a physical button of an electronic device to overcome the limitations described.

### BRIEF DESCRIPTION OF THE DRAWINGS

FIG. 1 is a block diagram of one embodiment of an electronic device including a function execution system.

FIG. 2 is a schematic diagram of one embodiment of a coordinate system in three dimensions established for the electronic device in FIG. 1.

FIG. 3 is a flowchart of one embodiment of a method for executing multiple functions of a physical button of the electronic device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

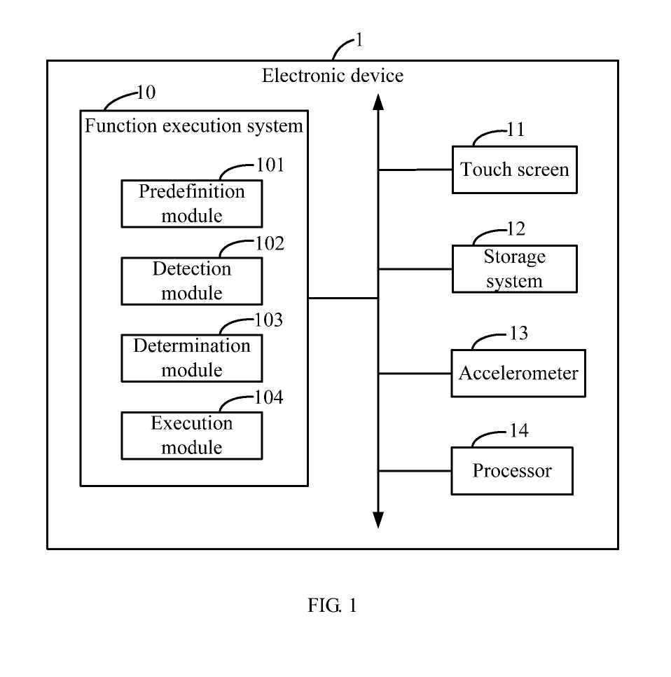

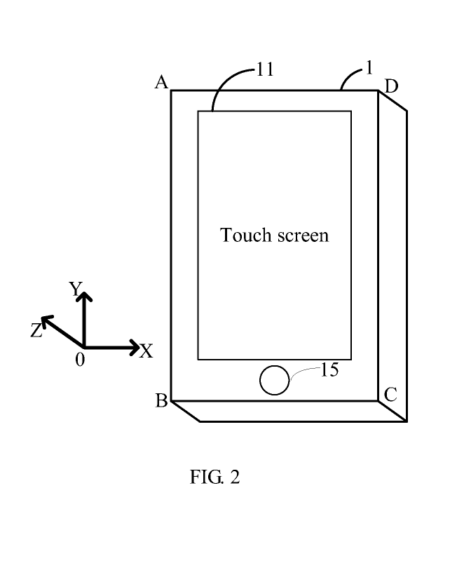

FIG. 1 is a block diagram of one embodiment of an electronic device 1 including a function execution system 10. In the embodiment, the electronic device 1 further includes a touch screen 11, a storage system 12, an accelerometer 13, at least one processor 14, and at least one physical button 15 (shown in FIG. 2). In one embodiment, the at least one physical button 15 is positioned on the surface of the electronic device 1. For example, the physical button 15 can be a power button or a volume control button. The accelerometer 13 is configured for sensing a direction of gravity of the electronic device 1. In one embodiment, the electronic device 1 may be, for example, a mobile phone, a personal digital assistant, a handheld game console or a tablet computer. FIG. 1 is just one example of the electronic device 1 that can be included with more or fewer components than shown in other embodiments, or have a different configuration of the various components.

The function execution system 10 may be in form of one or more programs that are stored in the storage system 12 and executed by the at least one processor 14. The function execution system 10 can detect a placement state of the electronic device 1 via the accelerometer 13 when the electronic device 1 is handheld or placed in a three-dimensional space. The placement state of the electronic device 1 is defined as how the electronic device 1 is placed or handheld. For example, the electronic device 1 is placed on a desk with the touch screen 11 in a horizontal plane. Furthermore, if the function execution system 10 is enabled by a user of the electronic device 1, the function execution system 10 can control the physical button 15 to execute multiple functions according to the different placement states of the electronic device 1. If the function execution system 10 is disabled by the user, the physical button 15 executes a default function. For example, if the execution system 10 is disabled, then the physical button 15 may just correspond to the power button that is used for turning on or turning off the electronic device 1.

In one embodiment, the storage system 12 may be a random access memory for temporary storage of information, and/or a read only memory for permanent storage of information. In other embodiments, the storage system 12 may also be an external storage device, such as a storage card or a data storage medium. The at least one processor 14 executes computerized operations of the electronic device 1 and other applications, to provide functions of the electronic device 1.

In the embodiment, the function execution system 10 may include a predefinition module 101, a detection module 102, a determination module 103, and an execution module 104. The modules 101-104 may comprise a plurality of functional modules each comprising one or more programs or computerized codes that can be accessed and executed by the at least one processor 14. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable storage medium or other storage device. Some non-limiting examples of non-transitory computer-readable storage medium include CDs, DVDs, Blu-ray Discs, flash memory, and hard disk drives.

The predefinition module 101 predefines multiple functions of the physical button 15, and predefines a relationship between each of the multiple functions and each of the placement states of the electronic device 1. For example, if the electronic device 1 runs a media player software for playing music, the predefined relationship may include: (1) if the electronic device 1 is placed with the touch screen 11 in a horizontal plane when the physical button 15 is pressed, the electronic device 1 suspends running the media player software; (2) if the electronic device 1 is placed with the touch screen 11 perpendicular to the horizontal plane and a width side (i.e., BC side in FIG. 2) of the touch screen 11 parallel to the horizontal plane when the physical button 15 is pressed, the electronic device 1 stops running the media player software; and (3) if the electronic device 1 is placed with the touch screen 11 perpendicular to the horizontal plane and a length side (i.e., AB side in FIG. 2) of the touch screen 11 parallel to the horizontal plane when the physical button 15 is pressed, the electronic device 1 starts running the media player software.

The detection module 102 detects a placement state of the electronic device 1 according to the direction of gravity sensed by the accelerometer 13 when the physical button 15 is pressed. For example, the detection module 102 can establish a three dimensional (3D) coordinate system for the electronic device 1. Referring to FIG. 2, a direction of the width side of the touch screen 11 is an X-axis of the 3D coordinate system, a direction of the length side of the touch screen 11 is a Y-axis of the 3D coordinate system, and a direction perpendicular to the touch screen 11 is a Z-axis of the 3D coordinate system. A plane with the X-axis and the Y-axis is defined as XY plane, a plane with the Y-axis and the Z-axis is defined as YZ plane, and a plane with the X-axis and the Z-axis is defined as XZ plane. If the XY plane is perpendicular to the direction of gravity, the electronic device 1 is placed with the touch screen 11 in the horizontal plane. If the XZ plane is perpendicular to the direction of gravity, the electronic device 1 is placed with the touch screen 11 perpendicular to the horizontal plane and the width side of the touch screen 11 parallel to the horizontal plane. If the YZ plane is perpendicular to the direction of gravity, the electronic device 1 is placed with the touch screen 11 perpendicular to the horizontal plane and the length side of the touch screen 11 parallel to the horizontal plane.

The determination module 103 determines a function of the physical button 15 corresponding to the placement state of the electronic device 1 according to the predefined relationship. For example, if the placement state of the electronic device 1 is that the electronic device 1 is placed with the touch screen 11 in horizontal plane, the determination module 103 determines that the physical button 15 suspends running the media player software.

The execution module 104 controls the electronic device 1 to execute the determined function of the physical button 15, such as suspending running the media player software.

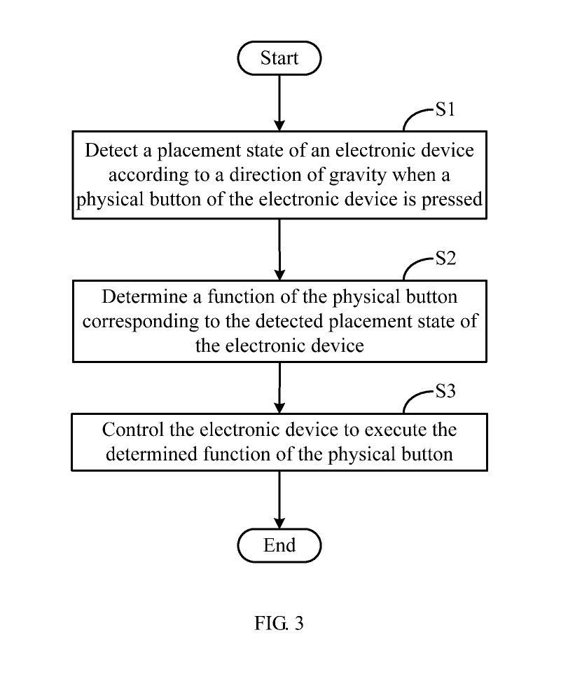

FIG. 3 is a flowchart of one embodiment of a method for executing multiple functions of a physical button 15 of the electronic device 1 of FIG. 1. Depending on the embodiment, additional steps may be added, others removed, and the ordering of the steps may be changed.

Before step S1, the predefinition module 101 predefines multiple functions of the physical button 15, and predefines a relationship between each of the multiple functions and each of the placement states of the electronic device 1.

In step S1, the detection module 102 detects a placement state of the electronic device 1 according to a direction of gravity sensed by the accelerometer 13 when the physical button 15 is pressed.

In step S2, the determination module 103 determines a function of the physical button 15 corresponding to the placement state of the electronic device 1 according to the predefined relationship.

In step S3, the execution module 104 controls the electronic device 1 to execute the determined function of the physical button 15, such as suspending running the media player software.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a storage system;
at least one processor;
at least one physical button;
one or more programs stored in the storage system and executed by the at least one processor, the one or more programs comprising:
a detection module that detects a placement state of the electronic device when the physical button is pressed;
a predefinition module that predefines multiple functions of the physical button, and predefines a relationship between each of the multiple functions and each placement state of the electronic device;
a determination module that determines a function of the physical button corresponding to the detected placement state of the electronic device according to the predefined relationship; and
an execution module that controls the electronic device to execute the determined function of the physical button.

2. The electronic device of claim 1, wherein the at least one physical button is positioned on a surface of the electronic device.

3. The electronic device of claim 1, further comprising an accelerometer for sensing a direction of gravity of the electronic device.

4. The electronic device of claim 3, wherein the detection module detects the placement state of the electronic device according to the direction of gravity of the electronic device sensed by the accelerometer.

5. A method for executing multiple functions of a physical button of an electronic device, the method comprising:
detecting a placement state of the electronic device when the physical button is pressed;
predefining multiple functions of the physical button, and predefining a relationship between each of the multiple functions and each placement state of the electronic device;
determining a function of the physical button corresponding to the detected placement state of the electronic device according to the predefined relationship; and
controlling the electronic device to execute the determined function of the physical button.

6. The method of claim 5, wherein the at least one physical button is positioned on a surface of the electronic device.

7. The method of claim 5, wherein the electronic device comprises an accelerometer for sensing a direction of gravity of the electronic device.

8. The method of claim 7, wherein the placement state of the electronic device is detected according to the direction of gravity of the electronic device sensed by the accelerometer.

9. A non-transitory computer-readable storage medium storing a set of instructions, the set of instructions capable of being executed by a processor of an electronic device, causes the processor to execute a method for executing multiple functions of a physical button of the electronic device, the method comprising:
detecting a placement state of the electronic device when the physical button is pressed;
predefining multiple functions of the physical button, and predefining a relationship between each of the multiple functions and each placement state of the electronic device;
determining a function of the physical button corresponding to the detected placement state of the electronic device according to the predefined relationship; and
controlling the electronic device to execute the determined function of the physical button.

10. The storage medium of claim 9, wherein the at least one physical button is positioned on a surface of the electronic device.

11. The storage medium of claim 9, wherein the electronic device comprises an accelerometer for sensing a direction of gravity of the electronic device.

12. The storage medium of claim 11, wherein the placement state of the electronic device is detected according to the direction of gravity of the electronic device sensed by the accelerometer.
